(19) United States
(12) Patent Application Publication
(10) Pub. No.: US 2026/0012859 A1
(43) Pub. Date: Jan. 8, 2026

(54) BROADCAST INFORMATION SIGNALING IN MULTI-RAT SPECTRUM SHARING SCENARIOS

(71) Applicant: Lenovo (United States) Inc., Morrisville, NC (US)

(72) Inventors: Prateek BASU MALLICK, Dreieich (DE); Alexander Golitschek Edler von Elbwart, Darmstadt (DE); Joachim LÖHR, Wiesbaden (DE)

(21) Appl. No.: 19/327,816

(22) Filed: Sep. 12, 2025

(51) Int. Cl. H04W 36/00; H04W 16/14; H04W 48/20

(52) U.S. Cl. CPC H04W 36/0072; H04W 16/14; H04W 48/20

(57) ABSTRACT

Various aspects of the present disclosure relate to combining or integrating the broadcast of system information two different radio access technologies in a single transmission of primary system information by a cell, base station, or other network entity. For example, a synchronization signal block (SSB) associated with a first radio access technology may include information (e.g., in a synchronization signal and/or physical broadcast channel) that identifies a cell broadcasting the information as supporting a different radio access technology. The SSB, embedding or otherwise including certain RAT information, may be useful to user equipment seeking access to different radio access technologies.

### TECHNICAL FIELD

The present disclosure relates to wireless communications, and more specifically to wireless communication (e.g., transmitting, receiving, broadcasting) of system information in multi-radio access technology (RAT) spectrum sharing (MRSS) scenarios.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems for signaling broadcast information, such as primary broadcast information, for MRSS and other spectrum migration scenarios.

A UE for wireless communication is described. The UE may be configured to, capable of, or operable to perform one or more operations as described herein. For example, the UE may comprise one or more memories and one or more processors coupled with the one or more memories and individually or collectively configured to cause the UE to receive a synchronization signal block (SSB) from a first cell, determine, based at least in part on system information associated with the received SSB, whether the first cell supports a first radio access technology or a second radio access technology different than the first radio access technology, and perform a cell selection procedure or a cell re-selection procedure based at least in part on the determination.

A processor for wireless communication is described. The processor may be configured to, capable of, or operable to perform one or more operations as described herein. For example, the processor may comprise one or more memories and one or more controllers coupled with the one or more memories and individually or collectively configured to cause the processor to receive an SSB from a first cell, determine, based at least in part on system information associated with the received SSB, whether the first cell supports a first radio access technology or a second radio access technology different than the first radio access technology, and perform a cell selection procedure or a cell re-selection procedure based at least in part on the determination.

A method performed or performable by the UE is described. The method may comprise receiving an SSB from a first cell, determining, based at least in part on system information associated with the received SSB, whether the first cell supports a first radio access technology or a second radio access technology different than the first radio access technology, and performing a cell selection procedure or a cell re-selection procedure based at least in part on the determination.

In some implementations of the UE, processor, and method described herein, wherein the SSB comprises one or more of a primary synchronization signal or a secondary synchronization signal, the UE, processor, and method may further be configured to, capable of, performed, performable, or operable to detect one or more of the primary synchronization signal or the secondary synchronization signal based at least in part on the UE supporting the second radio access technology, wherein the SSB is received from the first cell based at least in part on one or more of the detected primary synchronization signal or the detected secondary synchronization signal.

In some implementations of the UE, processor, and method described herein, wherein the SSB comprises one or more physical broadcast channels, the UE, processor, and method may further be configured to, capable of, performed, performable, or operable to receive the system information via at least one physical broadcast channel of the SSB, determine that the first cell supports the second radio access technology based at least in part on the received system information via the at least one physical broadcast channel of the SSB, and camp on the first cell during the cell selection procedure or the cell re-selection procedure based at least in part on the first cell supporting the second radio access technology.

In some implementations of the UE, processor, and method described herein, wherein the SSB comprises one or more physical broadcast channels, the UE, processor, and method may further be configured to, capable of, performed, performable, or operable to receive the system information via at least one physical broadcast channel of the SSB or determine an absence of the system information in the at least one physical broadcast channel of the SSB and determine that the first cell lacks support for the second radio access technology based at least in part on the received system information via the at least one physical broadcast channel of the SSB or the determined absence of the system information in the at least one physical broadcast channel of the SSB, wherein the cell selection procedure or the cell re-selection procedure is performed based at least in part on the determination.

In some implementations of the UE, processor, and method described herein, the UE, processor, and method may further be configured to, capable of, performed, performable, or operable to camp on the first cell during the cell selection procedure or the cell re-selection procedure based at least in part on the first cell lacking support for the second radio access technology, wherein the cell selection procedure or the cell re-selection procedure comprises a cell search for a second cell that supports the second radio access technology.

In some implementations of the UE, processor, and method described herein, the UE, processor, and method may further be configured to, capable of, performed, performable, or operable to determine that a signal quality associated with the first cell satisfies a threshold value and camp on the first cell during the cell selection procedure or the cell re-selection procedure based at least in part on the signal quality associated with the first cell satisfying the threshold value.

In some implementations of the UE, processor, and method described herein, the system information includes at least one bit of a master information block associated with a physical broadcast channel of the SSB, and wherein a value of the at least one bit is indicative of whether the first cell supports the first radio access technology or the second radio access technology.

In some implementations of the UE, processor, and method described herein, the master information block is defined by a message class extension within the system information included in the physical broadcast channel of the SSB.

In some implementations of the UE, processor, and method described herein, wherein the SSB comprises one or more physical broadcast channels, the UE, processor, and method may further be configured to, capable of, performed, performable, or operable to perform blind decoding of the physical broadcast channel on one or more symbols; an determine whether the first cell supports the first radio access technology or the second radio access technology based at least in part on whether the physical broadcast channel is decodable on the one or more symbols.

In some implementations of the UE, processor, and method described herein, the system information indicates one or more of a core network type supported by the first cell or a service supported by the first cell.

In some implementations of the UE, processor, and method described herein, to determine whether the first cell supports the first radio access technology or the second radio access technology, the UE, processor, and method may further be configured to, capable of, performed, performable, or operable to determine that the first cell supports the second radio access technology based at least in part on one or more of: a reserved cell identity of the first cell; a specific value of a frequency domain offset associated with the SSB; or a specific value of a parameter associated with a system information block (SIB) of the SSB.

In some implementations of the UE, processor, and method described herein, the first radio access technology comprises 5G radio access technology and wherein the second radio access technology comprises 6G radio access technology.

A network entity for wireless communication is described. The network entity may be configured to, capable of, or operable to perform one or more operations as described herein. For example, the network entity may comprise one or more memories and one or more processors coupled with the one or more memories and individually or collectively configured to cause the network entity to transmit an SSB associated with a first cell of the network entity, wherein the SSB is associated with a first radio access technology, and wherein the SSB includes an indication that the first cell supports services provided by a second radio access technology and receive a cell access request from a UE to access the services provided by the second radio access technology.

A method performed or performable by the network entity is described. The method may comprise transmitting an SSB associated with a first cell of the network entity, wherein the SSB is associated with a first radio access technology, and wherein the SSB includes an indication that the first cell supports services provided by a second radio access technology and receiving a cell access request from a UE to access the services provided by the second radio access technology.

In some implementations of the network entity and method described herein, the indication that the first cell supports services provided by the second radio access technology is within a primary synchronization signal (PSS) of the SSB.

In some implementations of the network entity and method described herein, the indication that the first cell supports services provided by a second radio access technology is within a secondary synchronization signal (SSS) of the SSB.

In some implementations of the network entity and method described herein, the indication that the first cell supports services provided by a second radio access technology is within a physical broadcast channel (PBCH) of the SSB.

In some implementations of the network entity and method described herein, the indication that the first cell supports services provided by a second radio access technology is within a master information block (MIB) of the PBCH.

In some implementations of the network entity and method described herein, the indication that the first cell supports services provided by a second radio access technology is within a system information block (SIB) of the PBCH.

In some implementations of the network entity and method described herein, the indication that the first cell supports services provided by a second radio access technology includes: a cell identity extension offset associated with the first cell; a bit that represents the second radio access technology is supported by the first cell, and a request for a user equipment (UE) to camp on the first cell using resources provided by the first radio access technology, and combinations thereof.

### BRIEF DESCRIPTION OF THE DRAWINGS

FIG. 1 illustrates an example of a wireless communications system in accordance with aspects of the present disclosure.

FIGS. 2-3B illustrate example resource diagrams in accordance with aspects of the present disclosure.

FIGS. 4-5 illustrate other example resource diagrams in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

A wireless communications system may enable dual steering, MRSS, and/or efficient inter-RAT mobility to support transitions (e.g., switching) between different RATs (e.g., 5G to 6G, or among other suitable radio access technologies). Dual steering, which provides a 5G or 6G-only spectrum (e.g., via network-controlled steering-switching-splitting rules), may provide mobility solutions, such as application-driven inherent load balancing features. For example, internet protocol (IP) layer mobility, based on the network-controlled rules, may switch traffic from one RAT to another in response to changing network conditions, thereby complementing access layer mobility. In such cases, access layer mobility may be simplified to provide fewer, but more secure, mobility options.

MRSS, inspired by dynamic spectrum sharing (DSS) between 4G and 5G, facilitates migration between RATs when, for example, spectrum availability for a 6G RAT is limited. Conventional MRSS implementations, however, provide migration via transmission of synchronization signals and primary broadcast information separately for each RAT (e.g., 5G and 6G). Such separate transmissions may be inefficient and resource-intensive, as access to both RATs may require effectively increasing (e.g., doubling) resources (e.g., time and frequency resources, NE operations).

The present disclosure addresses such inefficiencies by combining or integrating transmission (e.g., broadcast) of system information for both RATs in a single transmission (e.g., a single SSB). For example, an SSB associated with a 5G RAT (e.g., a first RAT) may include information (e.g., in a synchronization signal and/or broadcast channel) that identifies a cell broadcasting the information as supporting a 6G RAT (e.g., a second RAT). The SSB, embedding, containing, or otherwise including the information associated with the 6G RAT, may assist UEs in obtaining access to different RATs (e.g., the 5G RAT or the 6G RAT).

By providing such information in the SSB (or other synchronization signals), the wireless communications system may minimize signaling overheads for MRSS scenarios by employing a single transmission to provide system information for multiple RATs. Further, UEs may identify the RAT associated with a cell early in an access procedure with the cell, reducing the signaling performed by the UEs when attempting to access services not supported by the UEs, among other benefits.

Aspects of the present disclosure are described in the context of a wireless communications system.

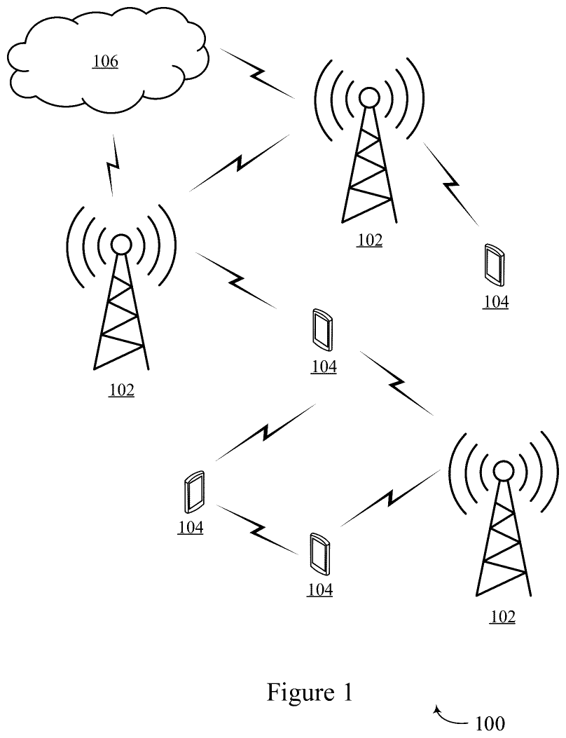

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the wireless communications system 100 may introduce efficient transmissions and/or signaling within MRSS and other spectrum migration scenarios by integrating information for multiple RATs (e.g., 5G and 6G, and/or other suitable radio access technologies beyond 5G and 6G) into communicated (e.g., broadcasted) system information, such as SSBs (and components of the SSBs).

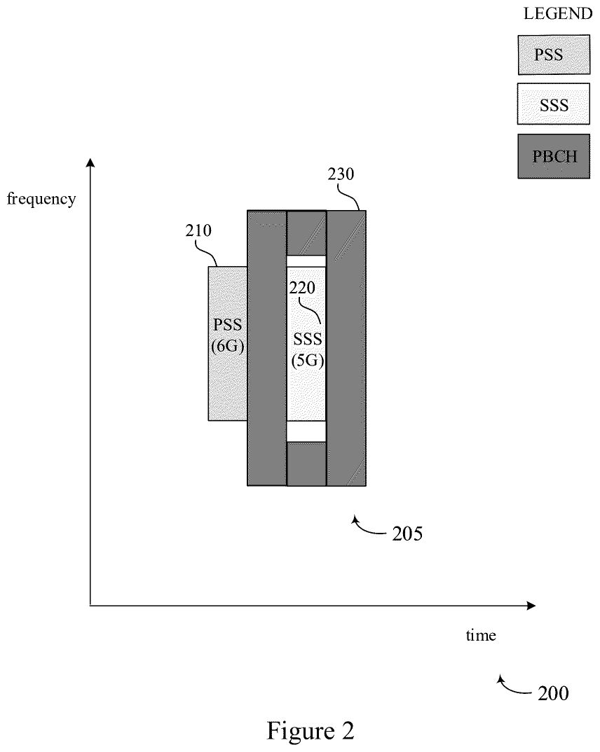

FIG. 2 illustrates an example resource diagram 200 in accordance with aspects of the present disclosure. In some examples, the resource diagram 200 implements or is implemented by aspects of the wireless communications system 100. For example, the resource diagram 200 may be implemented by a UE and/or an NE, which may be an example of an NE 102 and a UE 104 as described with reference to FIG. 1. The resource diagram 200 may include one or more of time (e.g., slots, subframes, or symbols) and frequency (e.g., subcarriers) resources. The resource diagram 200 may include one or more time-frequency resource for transmission of an SSB 205. The SSB 205 may include one or more of a PSS 210, an SSS 220, and PBCH 230.

An NE 102 associated with a cell for a first RAT (e.g., 6G RAT) may transmit (e.g., broadcast) the SSB 205 within a wireless communication system, to one or multiple UEs 104. In the example the cell supports 6G RAT, the cell may be referred to as a 6G cell. In some cases, a time-frequency resource grid for one or more synchronization signals (e.g., a PSS, an SSS) may be corresponding in structure to a time-frequency resource grid for one or more synchronization signals (e.g., a PSS, an SSS) associated with a second RAT (e.g., 5G RAT). In the example of FIG. 2, the PSS 210 may be associated with a synchronization signal sequence for 6G RAT, and different from a synchronization signal sequence for 5G RAT, and an SSS 220 and PBCH 230 may each be associated with 5G RAT.

In some cases, the synchronization signal sequence may utilize forward (e.g., normal) and reverse mapping to corresponding time-frequency resources. An inversion of the sequence order in the time domain may result in a corresponding inversion of the sequence order in the frequency domain (e.g., due to Fourier transform properties), thereby enabling a simplified implementation for generation and storing the synchronization signal sequence. Example synchronization signal sequences may be found in commonly-assigned U.S. patent application Ser. No. 19/300,303, filed on Aug. 14, 2025, entitled SYNCHRONIZATION SEQUENCE FOR WIRELESS COMMUNICATION SYSTEMS, which is incorporated by reference in its entirety.

Accordingly, the SSB 205 may correspond to a 5G RAT, also referred to as a 5G SSB (e.g., including the SSS 220 and/or the PBCH 230), and may carry information (e.g., a synchronization signal sequence of the PSS 210) that indicates the NE 102 associated with a cell transmitting (e.g., broadcasting) the SSB 205 is a 6G cell.

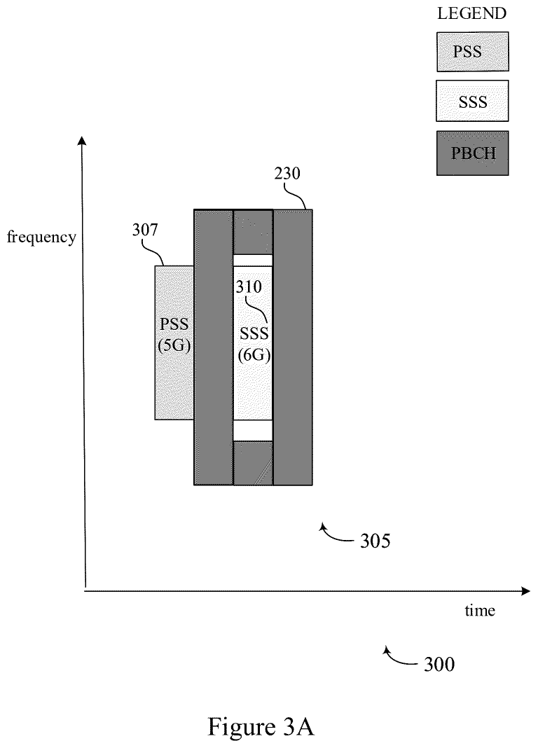

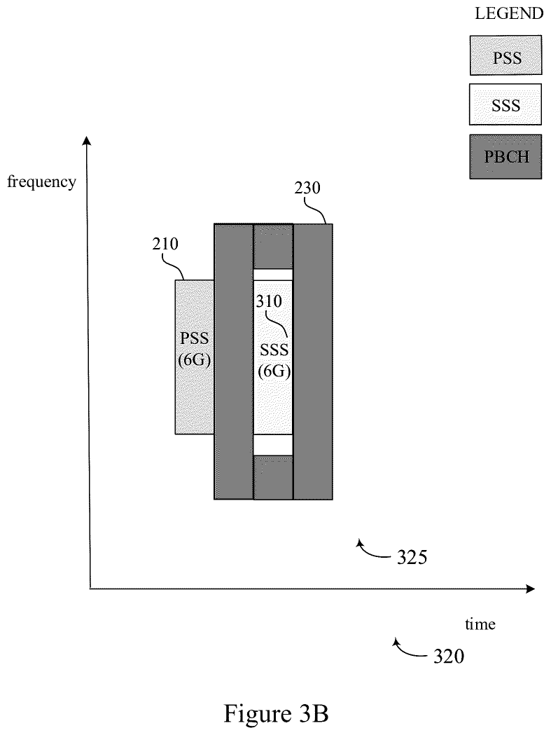

FIG. 3A illustrates a resource diagram 300 in accordance with aspects of the present disclosure. In some examples, the resource diagram 300 implements or is implemented by aspects of the wireless communications system 100. For example, the resource diagram 300 may be implemented by a UE and/or an NE, which may be an example of an NE 102 and a UE 104 as described with reference to FIG. 1. The resource diagram 300 may include one or more of time (e.g., slots, subframes, or symbols) and frequency (e.g., subcarriers) resources. The resource diagram 300 may include one or more time-frequency resource for transmission of an SSB 305. The SSB 305 may include one or more of a PSS 307, an SSS 310, and PBCH 230.

An NE 102 associated with a cell for a first RAT (e.g., 6G RAT) may transmit (e.g., broadcast) the SSB 305 within a wireless communication system, to one or multiple UEs 104. In the example the cell supports 6G RAT, the cell may be referred to as a 6G cell. In some cases, a time-frequency resource grid for one or more synchronization signals (e.g., a PSS, an SSS) may be corresponding in structure to a time-frequency resource grid for one or more synchronization signals (e.g., a PSS, an SSS) associated with a second RAT (e.g., 5G RAT).

In the example of FIG. 3A, the SSS 310 may be associated with synchronization signal sequence that is associated for 6G RAT (and different from a synchronization signal sequence for 5G RAT) and a PSS 307 and PBCH 230 that may each be associated with 5G.

Accordingly, the SSB 305 may correspond to a 5G RAT, also referred to as a 5G SSB (e.g., including the PSS 305 and/or the PBCH 230), and may carry information (e.g., a synchronization signal sequence of the SSS 310) that indicates the NE 102 associated with a cell broadcasting the SSB 305 is a 6G cell.

In some examples, both of the synchronization signals may include information indicative of a specific RAT.

FIG. 3B illustrates a resource diagram 320 in accordance with aspects of the present disclosure. In some examples, the resource diagram 320 implements or is implemented by aspects of the wireless communications system 100. For example, the resource diagram 320 may be implemented by a UE and/or an NE, which may be an example of an NE 102 and a UE 104 as described with reference to FIG. 1. The resource diagram 320 may include one or more of time (e.g., slots, subframes, or symbols) and frequency (e.g., subcarriers) resources. The resource diagram 320 may include one or more time-frequency resource for transmission of an SSB 325. The SSB 325 may include one or more of the PSS 210, the SSS 310, and the PBCH 230.

An NE 102 associated with a cell for a first RAT (e.g., 6G RAT) may transmit (e.g., broadcast) the SSB 325 within a wireless communication system, to one or multiple UEs 104. In the example the cell supports 6G RAT, the cell may be referred to as a 6G cell. In some cases, a time-frequency resource grid for one or more synchronization signals (e.g., a PSS, an SSS) may be corresponding in structure to a time-frequency resource grid for one or more synchronization signals (e.g., a PSS, an SSS) associated with a second RAT (e.g., 5G RAT).

In the example of FIG. 3B, the SSB 325 includes the PSS 210 and the SSS 310, where both synchronization signals are associated with sequences indicative of or for the 6G RAT, while the PBCH 230 includes information associated with the 5G RAT.

In some cases, variations of the broadcast system information (e.g., information elements (IEs) and/or associated values) may differ from the information broadcast in the 5G RAT and, thus, may indicate the NE 102 and/or associated cell broadcasting the system information is a 6G cell. A UE (e.g., the UE 104) receiving the system information (e.g., the UE 104), which may be configured to utilize 5G RAT and/or 6G RAT services, may select the IEs within the system information (e.g., within a PBCH/MIB) based on its configuration and/or capabilities. For example, when the UE 104 is a 5G UE, the UE 104 may ignore any 6G information with the system information, while a 6G UE may accept and use the 6G information to camp on a 6G cell or otherwise perform a cell access procedure.

In some cases, a 5G cell and a 6G cell (e.g., of a single NE 102 and/or different NEs 102) may utilize the same frequency resources when broadcasting their system information (e.g., SSBs 205, 305, 325), but alternate their broadcasts over the time domain (e.g., each cell may be associated with one or more time offsets). In some cases, the 5G and 6G cells may each be associated with a frequency offset, where different frequency resources are used when broadcasting system information.

In some examples, an SSB (or other system information) of a first RAT (e.g., provided by a 5G cell) may include an additional PBCH space (e.g., a symbol) for system information (e.g., primary information) associated with a second RAT (e.g., provided by a 6G cell).

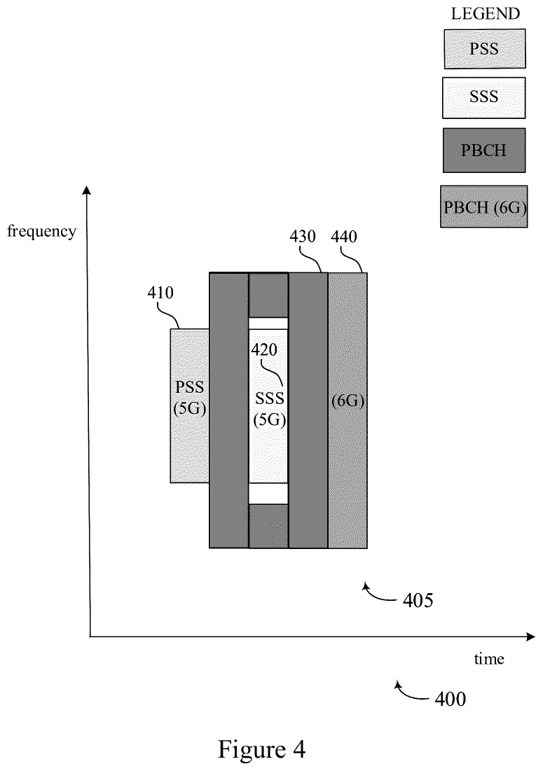

FIG. 4 illustrates an example resource diagram 400 with RAT information within PBCH symbols in accordance with aspects of the present disclosure. In some examples, the resource diagram 400 implements or is implemented by aspects of the wireless communications system 100. For example, the resource diagram 400 may be implemented by a UE and/or an NE, which may be an example of an NE 102 and a UE 104 as described with reference to FIG. 1. The resource diagram 400 may include one or more of time (e.g., slots, subframes, or symbols) and frequency (e.g., subcarriers) resources. The resource diagram 400 may include one or more time-frequency resource for transmission of an SSB 405. The SSB 405 may include one or more of a 5G PSS 410, a 5G SSS 420, a 5G PBCH 430, and a 6G PBCH 440.

An NE 102 associated with a cell for a first RAT (e.g., 6G RAT) may transmit (e.g., broadcast) the SSB 405 within a wireless communication system, to one or multiple UEs 104. In the example the cell supports 6G RAT, the cell may be referred to as a 6G cell. In some cases, a time-frequency resource grid for one or more synchronization signals (e.g., a PSS, an SSS) may be corresponding in structure to a time-frequency resource grid for one or more synchronization signals (e.g., a PSS, an SSS) associated with a second RAT (e.g., 5G RAT).

In the example of FIG. 4, the SSB 405 includes the PSS 410, the SSS 420, and the 5G PBCH 430 (e.g., in symbols 1, 2, and 3). The SSB 405 also includes the 6G PBCH 440 in a new space (e.g., a new symbol 4). Thus, the SSB 405 may provide or include a sufficient number of time-frequency resources for primary broadcast information of two different RATs (e.g., 5G and 6G RATs).

In some cases, the 5G PBCH 430 and 6G PBCH 440 may include primary broadcast information for the different RATs. The primary broadcast information may include a RAT and/or core network (e.g., the CN 106) type indication, such as an indication of a 5G CN or a 6G CN, a feature type indication, which indicates some or all features (e.g., network energy saving, NTN, IMS voice calling, and so on) supported or not supported (e.g., currently or on a long-term basis) by the 5G or 6G cell. Further, the primary broadcast information may include additional or reserved bits for undefined, planned, or future features to be supported by the RAT (e.g., to avoid backward compatibility issues). For example, each reserved bit may represent a feature or a group of features and be explicitly indicated by the cell. In some cases, the additional or reserved bits may be excepted from any barring of a cell. As an example, when a feature-X is indicated as part of bits 2 and 4 (out of 8 bits), a UE supporting feature-X (e.g., a current or future feature) may already implement in a current release when any of the bits 2 or 4 is set to ‘TRUE.’ Further, the primary broadcast information may include an indication requesting UEs supporting a certain RAT (e.g., a 6G RAT) to camp on the broadcasting cell using resources from a different RAT (e.g., a 5G RAT), such as resources received via 5G system information (e.g., a 5G SIB1); and so on.

In some cases, while the PBCH 440 is placed or positioned at symbol 4 of the SSB 400, the PBCH 440 may be placed or positioned at other symbols (e.g., symbols 1-3) that are known to a receiving UE (e.g., a 6G UE).

In some examples, the 5G PBCH 430 may include an indication of the 6G cell.

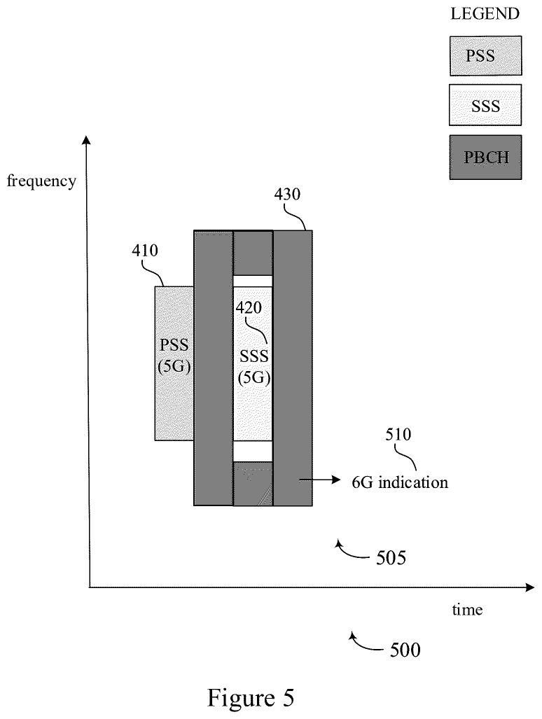

FIG. 5 illustrates an example resource diagram 500 with RAT information within a PBCH symbol in accordance with aspects of the present disclosure. In some examples, the resource diagram 500 implements or is implemented by aspects of the wireless communications system 100. For example, the resource diagram 500 may be implemented by a UE and/or an NE, which may be an example of an NE 102 and a UE 104 as described with reference to FIG. 1. The resource diagram 500 may include one or more of time (e.g., slots, subframes, or symbols) and frequency (e.g., subcarriers) resources. The resource diagram 500 may include one or more time-frequency resource for transmission of an SSB 505. The SSB 505 may include one or more of the PSS 410, the SSS 420, and the PBCH 430.

An NE 102 associated with a cell for a first RAT (e.g., 6G RAT) may transmit (e.g., broadcast) the SSB 505 within a wireless communication system, to one or multiple UEs 104. In the example the cell supports 6G RAT, the cell may be referred to as a 6G cell. In some cases, a time-frequency resource grid for one or more synchronization signals (e.g., a PSS, an SSS) may be corresponding in structure to a time-frequency resource grid for one or more synchronization signals (e.g., a PSS, an SSS) associated with a second RAT (e.g., 5G RAT).

The SSB 505 is broadcast by a 5G cell, and includes the 5G PSS 410, the 5G SSS 420, and the 5G PBCH 430. However, the 5G PBCH 430 may include a 6G indication 510, which represents or indicates the broadcasting NE 102 may also be or include a 6G cell (or provide certain 6G RAT services). Thus, the broadcasting NE 102, supporting both 5G and 6G RATs (e.g., aspects of both RATs), may utilize the same time-frequency resource to broadcast primary system information for two or multiple RATs supported by the NE 102 and/or associated cells.

In some cases, the 6G indication 510 may be incorporated into the 5G PBCH 430, as follows:

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}
In some cases, the 6G indication 510 may be incorporated via a message class
extension in a broadcast control channel (e.g., BCCH-BCH) message definition, as follows:

| | |
|---|---|
| BCCH-BCH-Message ::= | SEQUENCE { |
| message | BCCH-BCH-MessageType |

}

| | |
|---|---|
| BCCH-BCH-MessageType ::= | CHOICE { |
| mib | MIB, |
| messageClassExtension | SEQUENCE { } |

}

A 5G MIB, in some cases, may be defined in a message class extension, facilitating current and future 5G UEs (e.g., UEs associated with a future release) to receive the MIB with a structure defined by a current release.

In some cases, the 6G indication 510 may be blindly received and decoded by a UE. For example, 6G UEs may attempt to receive and decode the PBCH 430 (e.g., which may be sent and decoded separately on a 4^{th} symbol) and blindly scrambled with its own cyclic redundancy code (CRC)). When the UE successfully decodes the PBCH 430, the cell is a 6G cell; else the cell is a 5G cell (to the UE).

In some cases, the 6G indication 510 may include one or more identifiers or information elements (e.g., detectable by a 6G UE), including: a reserved cell identity (e.g., a specific identity, such as PCI #100, or a range of identities reserved for 6G cells); a bit or bitmap, one or more specific values of a k_{SSB} parameter (for a 5G SSB), where the k_{SSB} parameter is a frequency domain offset between an SSB and an overall resource block grid in number of subcarriers and is an extension of an SSB subcarrier offset (e.g., a value range of “ssb subcarrier offset” (e.g., as depicted herein) may be extended by an additional most significant bit encoded within a PBCH to form the k_{SSB}; one or more specific values of a pdcch-ConfigSIB1, which determines a common control resource set (CORESET), a common search space, and/or necessary physical downlink control channel (PDCCH) parameters to receive a broadcasted SIB1.

The 6G indication 510 may include various types of 6G specific information (as described herein), including an extension of a physical cell ID (PCI) range (e.g., 6G PCI=5G PCI+an indicated offset), a RAT and/or core network (e.g., the CN 106) type indication, a feature type indication, additional or reserved bits for undefined, planned, or future features to be supported by the RAT, an indication requesting UEs supporting a certain RAT (e.g., a 6G RAT) to camp on the broadcasting cell using resources from a different RAT (e.g., a 5G RAT), such as resources received via 5G system information (e.g., a 5G SIB1); and so on.

In some examples, when a 6G UE determines a 6G indication (e.g., the 6G indication 510) is contained in a PBCH received in an SSB. The 6G UE camps on the cell as a candidate for a 6G cell selection and reselection procedure, to receive 6G services provided by the 6G cell.

When the 6G UE determines there is no 6G indication, the 6G UE may search for further 6G cells in upper layers that have indicated 6G as a RAT preference and when there is at least one more 6G frequency remaining (e.g., to be scanned) for cell selection and reselection purpose When there is no further 6G frequency remaining and/or when a signal quality (a reference signal received power (RSRP) and/or a reference signal received quality (RSRQ)) is above a certain threshold, the 6G UE may transmit a request to a 5G cell to camp/access the cell. For example, the 6G UE, in a spectrum sharing scenario, may receive a signal in the PBCH and camp on the 5G cell to receive 5G services.

The cell (or network node), may thus provide time-frequency resources for both 5G and 6G services (e.g., using FMDA and/or TDMA), by transmitting system information (e.g., one or more SSBs) that are useful to accessing both RATs and that facilitate reception and support of cell access requests from UEs associated with both RATs (e.g., 5G UEs, 6G UEs, and/or UEs that support both RATs).

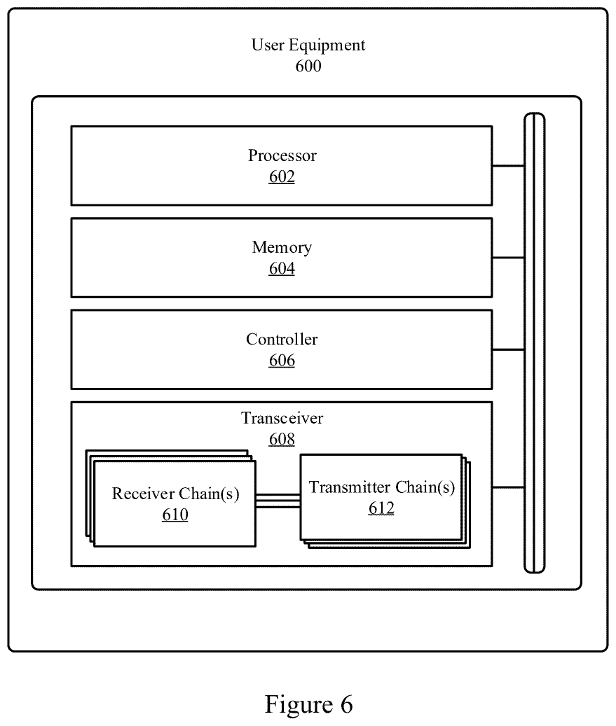

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving an SSB from a first cell, determining, based at least in part on system information associated with the received SSB, whether the first cell supports a first radio access technology or a second radio access technology different than the first radio access technology; and performing a cell selection procedure or a cell re-selection procedure based at least in part on the determination.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

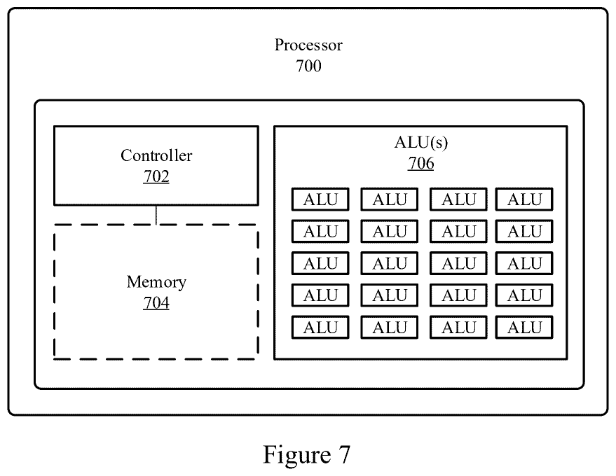

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The UE processor 700 may be configured to support a means for receiving an SSB from a first cell, determining, based at least in part on system information associated with the received SSB, whether the first cell supports a first radio access technology or a second radio access technology different than the first radio access technology; and performing a cell selection procedure or a cell re-selection procedure based at least in part on the determination.

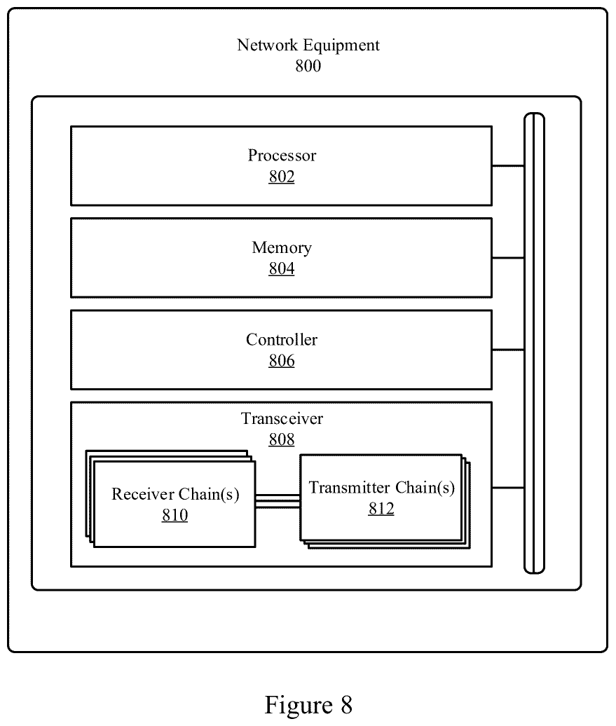

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for transmitting an SSB associated with a first cell of the network entity, wherein the SSB is associated with a first radio access technology, and wherein the SSB includes an indication that the first cell supports services provided by a second radio access technology; and receiving a cell access request from a UE to access the services provided by the second radio access technology.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

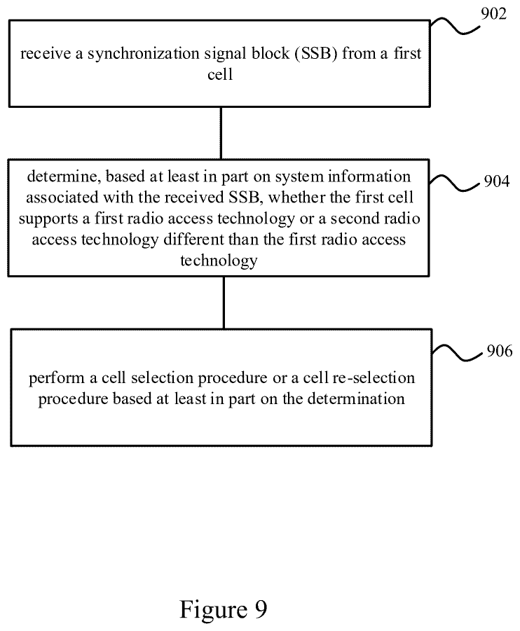

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include receiving an SSB from a first cell. The operations of 902 may be performed in accordance with examples as described herein. In some implementations, aspects of the operations of 902 may be performed by a UE as described with reference to FIG. 6.

At 904, the method may include determining, based at least in part on system information associated with the received SSB, whether the first cell supports a first radio access technology or a second radio access technology different than the first radio access technology. The operations of 904 may be performed in accordance with examples as described herein. In some implementations, aspects of the operations of 904 may be performed by a UE as described with reference to FIG. 6.

At 906, the method may include performing a cell selection procedure or a cell re-selection procedure based at least in part on the determination. The operations of 906 may be performed in accordance with examples as described herein. In some implementations, aspects of the operations of 906 may be performed by a UE as described with reference to FIG. 6.

It should be noted that the method described herein describes a possible implementation, and that the operations and the steps may be rearranged or otherwise modified and that other implementations are possible.

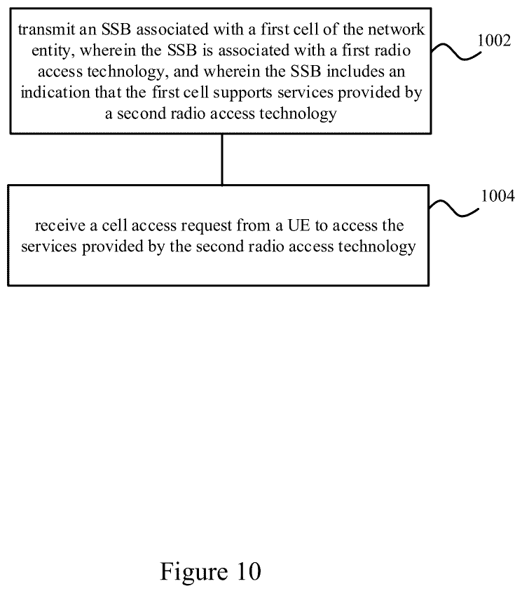

FIG. 10 illustrates a flowchart of a method in accordance with aspects of the present disclosure. The operations of the method may be implemented by an NE as described herein. In some implementations, the reader device may execute a set of instructions to control the function elements of the reader device to perform the described functions.

At 1002, the method may include transmitting an SSB associated with a first cell of the network entity, wherein the SSB is associated with a first radio access technology, and wherein the SSB includes an indication that the first cell supports services provided by a second radio access technology. The operations of 1002 may be performed in accordance with examples as described herein. In some implementations, aspects of the operations of 1002 may be performed by an NE as described with reference to FIG. 8.

At 1004, the method may include receiving a cell access request from a UE to access the services provided by the second radio access technology. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively configured to cause the UE to:
receive a synchronization signal block (SSB) from a first cell;
determine, based at least in part on system information associated with the received SSB, whether the first cell supports a first radio access technology or a second radio access technology different than the first radio access technology; and
perform a cell selection procedure or a cell re-selection procedure based at least in part on the determination.

2. The UE of claim 1, wherein the SSB comprises one or more of a primary synchronization signal or a secondary synchronization signal, and wherein the one or more processors are individually or collectively configured to cause the UE to:
detect one or more of the primary synchronization signal or the secondary synchronization signal based at least in part on the UE supporting the second radio access technology,
wherein the SSB is received from the first cell based at least in part on one or more of the detected primary synchronization signal or the detected secondary synchronization signal.

3. The UE of claim 1, wherein the SSB comprises one or more physical broadcast channels, and wherein the one or more processors are further individually or collectively configured to cause the UE to:
receive the system information via at least one physical broadcast channel of the SSB;
determine that the first cell supports the second radio access technology based at least in part on the received system information via the at least one physical broadcast channel of the SSB; and
camp on the first cell during the cell selection procedure or the cell re-selection procedure based at least in part on the first cell supporting the second radio access technology.

4. The UE of claim 1, wherein the SSB comprises one or more physical broadcast channels, and wherein the one or more processors are further individually or collectively configured to cause the UE to:
receive the system information via at least one physical broadcast channel of the SSB or determine an absence of the system information in the at least one physical broadcast channel of the SSB; and
determine that the first cell lacks support for the second radio access technology based at least in part on the received system information via the at least one physical broadcast channel of the SSB or the determined absence of the system information in the at least one physical broadcast channel of the SSB,
wherein the cell selection procedure or the cell re-selection procedure is performed based at least in part on the determination.

5. The UE of claim 4, wherein the one or more processors are further individually or collectively configured to cause the UE to:
camp on the first cell during the cell selection procedure or the cell re-selection procedure based at least in part on the first cell lacking support for the second radio access technology,
wherein the cell selection procedure or the cell re-selection procedure comprises a cell search for a second cell that supports the second radio access technology.

6. The UE of claim 4, wherein the one or more processors are further individually or collectively configured to cause the UE to:
determine that a signal quality associated with the first cell satisfies a threshold value; and
camp on the first cell during the cell selection procedure or the cell re-selection procedure based at least in part on the signal quality associated with the first cell satisfying the threshold value.

7. The UE of claim 1, wherein the system information includes at least one bit of a master information block associated with a physical broadcast channel of the SSB, and wherein a value of the at least one bit is indicative of whether the first cell supports the first radio access technology or the second radio access technology.

8. The UE of claim 7, wherein the master information block is defined by a message class extension within the system information included in the physical broadcast channel of the SSB.

9. The UE of claim 1, wherein the SSB comprises a physical broadcast channel, and wherein the one or more processors are further individually or collectively configured to cause the UE to:
perform blind decoding of the physical broadcast channel on one or more symbols; and
determine whether the first cell supports the first radio access technology or the second radio access technology based at least in part on whether the physical broadcast channel is decodable on the one or more symbols.

10. The UE of claim 1, wherein the system information indicates one or more of a core network type supported by the first cell or a service supported by the first cell.

11. The UE of claim 1, wherein, to determine whether the first cell supports the first radio access technology or the second radio access technology, the one or more processors are individually or collectively configured to cause the UE to:
determine that the first cell supports the second radio access technology based at least in part on one or more of:
a reserved cell identity of the first cell;
a specific value of a frequency domain offset associated with the SSB; or
a specific value of a parameter associated with a system information block (SIB) of the SSB.

12. The UE of claim 1, wherein the first radio access technology comprises fifth generation (5G) radio access technology and wherein the second radio access technology comprises sixth generation (6G) radio access technology.

13. A network entity for wireless communication, comprising:
one or more memories; and
one or more processors coupled with the one or more memories and individually or collectively configured to cause the network entity to:
transmit a synchronization signal block (SSB) associated with a first cell of the network entity,
wherein the SSB is associated with a first radio access technology, and
wherein the SSB includes an indication that the first cell supports services provided by a second radio access technology; and
receive a cell access request from a user equipment (UE) to access the services provided by the second radio access technology.

14. The network entity of claim 13, wherein the indication that the first cell supports services provided by the second radio access technology is within a primary synchronization signal (PSS) or a secondary synchronization signal (SSS) of the SSB.

15. The network entity of claim 13, wherein the indication that the first cell supports services provided by a second radio access technology is within a physical broadcast channel (PBCH) of the SSB.

16. The network entity of claim 15, wherein the indication that the first cell supports services provided by a second radio access technology is within a master information block (MIB) of the PBCH.

17. The network entity of claim 15, wherein the indication that the first cell supports services provided by a second radio access technology is within a system information block (SIB) of the PBCH.

18. The network entity of claim 12, wherein the indication that the first cell supports services provided by a second radio access technology includes:
a cell identity extension offset associated with the first cell;
a bit that represents the second radio access technology is supported by the first cell;
a request for a user equipment (UE) to camp on the first cell using resources provided by the first radio access technology; or
combinations thereof.

19. A method performed by a user equipment (UE), the method comprising:
receiving a synchronization signal block (SSB) from a first cell;
determining, based at least in part on system information associated with the received SSB, whether the first cell supports a first radio access technology or a second radio access technology different than the first radio access technology; and
performing a cell selection procedure or a cell re-selection procedure based at least in part on the determination.

20. A method performed by a network entity, the method comprising:
transmitting a synchronization signal block (SSB) associated with a first cell of the network entity,
wherein the SSB is associated with a first radio access technology, and
wherein the SSB includes an indication that the first cell supports services provided by a second radio access technology; and
receiving a cell access request from a user equipment (UE) to access the services provided by the second radio access technology.
